(19) United States
(12) Patent Application Publication
(10) Pub. No.: US 2026/0130337 A1
(43) Pub. Date: May 14, 2026

(54) Cat litter additive for detecting pH value of cat urine and a preparation method thereof

(71) Applicant: Shanghai Padik Technology Co., Ltd., Shanghai (CN)

(72) Inventors: Yanping Wang, Shanghai (CN); Yan Gu, Shanghai (CN)

(21) Appl. No.: 18/947,644

(22) Filed: Nov. 14, 2024

(51) Int. Cl. A01K 1/015; B01D 11/02

(52) U.S. Cl. CPC A01K 1/0155; B01D 11/0265; B01D 11/0288

(57) ABSTRACT

A cat litter additive for detecting pH value of cat urine, comprising starch, microcrystalline cellulose, organic solvents, binders, pH indicators, pH adjusters and water; Amount of the starch is 30-200 parts, the microcrystalline cellulose is 20-100 parts, the organic solvent is 10-60 parts, the binder is 1-20 parts, the pH indicator is 0.05-2 parts, the pH adjuster is 0.01-10 parts, the water is 0-100 parts; a preparation method for detecting the pH value of cat urine cat litter additive comprises five steps. The product obtained by the present invention can fit well the normal urine pH value range of cat, if the cat urine pH is located at 5.5-7.5 the indicator shows light green to dark green; if the pH value is lower than 5.5, the indicator shows orange yellow to yellow, if the PH value is greater than 7.5, the indicator shows cyan to blue.

### TECHNICAL FIELD

The invention relates to the technical field of pet products and a preparation method, in particular to a cat litter additive for detecting pH value of cat urine and a preparation method thereof.

### BACKGROUND TECHNOLOGY

Cats are carnivores, in a healthy state of natural diet, generally produce acidic urine, its pH is between 5.5 and 7.5, the optimal range is around 6 to 6.5. Diet and disease are the main factors that affect the pH of your cat's urine. Taking drugs, stress, strenuous exercise, etc., will also cause the pH of your cat's urine to shift. Most pet cats raised by families mainly eat commercial cat food, which contains vegetables and grains, which will increase the urine pH. Eating dry food and drinking too little water will also cause the urine pH to be alkaline. A small number of cats fed raw food, eat more meat, urine pH will be more acidic. Many diseases are associated with a change in urine pH from the normal range to acidic or alkaline; Such as metabolic or respiratory acidosis, fever, gout, emphysema, urinary stones, kidney stones, diabetes, leukemia and other diseases can have an acidic urine pH; Suffering from metabolic or respiratory alkalosis, frequent vomiting, urinary retention, cystitis, urinary tract infection, renal tubular acidosis, chronic glomerulonephritis and other diseases will appear alkaline urine pH. When your cat's urine is acidic, it is prone to calcium oxalate stones; When the cat urine is alkaline, it is easy to precipitate ammonium phosphate and form struvite stones. The occurrence of stones is easy to lead to urinary tract, bladder and kidney inflammation, and serious cases block the urinary tract, resulting in cat urine hematuria, critical life. Therefore, the abnormal pH value of cat urine can be used as an indication of some potential diseases to a certain extent, especially urinary tract diseases and kidney diseases. Therefore, by detecting the pH value of your cat's urine, you can detect the potential health problems of your cat in advance, and take corresponding measures in time to keep your cat in a healthy state.

China's patent No. CN110521613A, which disclosed a cat urine indicator cat litter and its preparation method, the technical scheme is based on deodorant, fiber powder, granules, adhesives, starch, silica gel as the litter matrix, adding pH indicator bromocresol green and phenolphthalein made of, if the PH value is lower than 5.4, the indicator will show blue green to yellow, When the PH value is greater than 8.2, the indicator appears light red to purple red. China's patent No. CN116158356A, which disclosed another kind of cat urine indicator cat litter and its preparation method, the technical scheme is made of soybean residue, corn flour, corn starch, flour, expanded corn flour, calcium carbonate, plant fiber, emulsified equalizing oil powder, guar gum, sodium polyacrylate as the cat litter matrix, adding the pH indicator bromothymol blue. When the pH of urine is 6.0-7.8, it does not change color; When the pH of urine is above 7.6, it is blue; And yellow when the pH of urine is below 6.0. Although the above patent realizes the purpose of its invention, it is limited by technology and has the following technical shortcomings. Specifically, the above technical solution directly selects cat litter as the detection substrate, which has a complex mass production process and high cost; The composition of cat litter is complex, which may affect the accuracy of pH indication; In addition, the pH indicating range of the prepared litter does not fit well into the normal pH range of your cat's urine.

Bromothymol blue is a commonly used acid-base indicator, which is often used as a respiratory reagent for aquatic organisms in biological experiments. The discoloration range of bromothymol blue aqueous solution is pH 6.0 to 7.6, yellow or light yellow under weakly acidic conditions, blue or light blue under neutral alkaline conditions, and green in the middle. Anthocyanin is a natural pigment, widely found in nature flowers and fruits, anthocyanin solution in acidic conditions is red, under neutral conditions for blue, under alkaline conditions, the solution from green to yellow; Anthocyanins extracted from purple potato have sufficient raw materials, and compared with anthocyanins extracted from traditional plants, they have strong stability to light and heat. Curcumin is a kind of natural polyphenol widely present in the roots and stems of turmeric. Curcumin solution is bright yellow under acidic conditions; Under alkaline conditions, the solution varies from red to reddish-brown; Anthocyanins and curcumin, as natural indicators, are widely used in food quality monitoring. Although the above natural pigments have the characteristics of non-toxic and harmless, a single natural pigment has certain limitations and can not reach the ideal indication range.

### SUMMARY OF INVENTION

In order to overcome the shortcomings of the existing cat urine indicating cat litter due to technical limitations, the material obtained by the relevant raw materials and preparation process can be added to a variety of cat litter, has the advantages of high flexibility and relatively low cost, and can fit the normal pH value of the cat urine well, and detect the pH value of the urine quickly and effectively. Long color retention time, high sensitivity, strong safety, and can achieve better detection effect of the cat urine pH value of the cat litter additive and preparation method.

The technical scheme adopted by the invention to solve the technical problem is:

The invention discloses a cat litter additive for detecting the pH value of cat urine. The materials used include starch, microcrystalline cellulose, organic solvent, binder, pH indicator, pH regulator and water. The amount of starch is 30-200 parts, microcrystalline cellulose is 20-100 parts, organic solvent is 10-60 parts, binder is 1-20 parts, pH indicator is 0.05-2 parts, pH regulator is 0.01-10 parts, water is 0 -100 parts; The starch is corn starch, tapioca starch, pea starch, mung bean starch, pre-gelatinized starch, hydroxymethyl starch or maltodextrin in any one or at least two of the combination; The organic solvent is ethanol, butanol, butanediol, ethylene glycol, ether, ethyl acetate, acetone, or pentane any one or at least two combination; The binder comprises any one or at least two combinations of guar gum, pectin, xanthan gum, propylene glycol alginate ester, sodium polyacrylate, hydroxypropyl methyl cellulose and sodium carboxymethyl cellulose; The indicator is bromothymol blue, purple potato anthocyanin, curcumin composition; The pH regulator is citric acid, sodium citrate, histidine, histidine, tris, EDTA-2Na, hydrochloric acid, sodium dihydrogen phosphate, disodium hydrogen phosphate, potassium dihydrogen phosphate, one or at least two of the combination.

Further, the starch, microcrystalline cellulose, organic solvent, binder, pH indicator, pH regulator and water composition are measured by weight part, Preferably, 50-120 parts of starch, 30-80 parts of microcrystalline cellulose, 20-40 parts of organic solvent, 5-10 parts of binder, 0.1-1 parts of pH indicator, 1-5 parts of pH regulator and 30-70 parts of water.

Further, the starch is preferably pre-gelatinized starch.

Further, the organic solvent is preferable to ethanol.

Further, the binder preferably guar gum.

Further, the pH regulator is preferably a combination of citric acid and EDTA-2Na.

The invention relates to a preparation method of a cat litter additive for detecting the pH value of cat urine, which includes the following process: (1) extracting anthocyanins from purple potato; (2) the pH indicator is mixed with organic solvent to obtain organic phase; (3) binder and water mixed to get water phase; (4) the aqueous phase and the organic phase are mixed to get the mixed liquid, add the pH regulator, adjust to the appropriate pH value to the additive liquid phase; (5) the liquid phase of the additive is dropped onto the starch base material, the starch base material is automatically clumped to form particles, the particles are separated and collected, and the cat litter additive is freeze-dried.

Further, the extraction of purple potato anthocyanins includes the following steps, S1: take purple potato powder, according to the solid-liquid ratio of 1:50 (g/ml) to add the extraction agent, the extraction agent is glacial acetic acid (mass fraction 1%) and ethanol mixture, magnetic stirring conditions for 4 h, speed 800 rpm; S2: After ultrasonic heating treatment, cooling to room temperature, standing for 24 h away from light, to fully combined, after vacuum filtration, purple potato anthocyanin solution was obtained; S3: The anthocyanin content in the obtained solution was measured by spectrophotometer.

Further, in the step S1, ethanol is 75%-100% by volume. Further, in step S1, the volume ratio of glacial acetic acid to ethanol is 1:1-2. Further, in the step S1, the ultrasonic heating condition is 20-30min, 45-50° C. Compared with the prior art, the invention has the following beneficial effects: By selecting a specific pH indicator combination and optimizing the production process, the prepared product can be added to a variety of cat litter, has high flexibility and relatively low cost, and can well fit the normal pH value range of the cat urine. If the pH value of the cat urine is 5.5-7.5, the indicator shows light green to dark green; If the PH value is lower than 5.5, the indicator shows orange yellow to yellow, if the PH value is greater than 7.5, the indicator shows cyan to blue, which can quickly and effectively detect the pH value of urine, and has the advantages of long color retention time, high sensitivity and strong safety. In summary, the invention has a good application prospect.

### BRIEF DESCRIPTION OF ACCOMPANY DRAWINGS

FIG. 1 is a rendering of the color of the litter additive for the pH value of the cat urine of the invention.

FIG. 2 is the color rendering effect diagram of the silica gel sand additive of the pH value of the urine of the cat.

FIG. 3 is the color rendering effect diagram of the tofu cat litter additive with pH value of the cat urine.

FIG. 4 is a schematic diagram of the color development of Examples 1-8 and Comparative Examples 1-4 under different pH conditions.

### Specific Embodiment of the Invention

Embodiment 1, a litter additive for detecting the pH value of urine of cats. The materials used include starch, microcrystalline cellulose, organic solvent, binder, pH indicator, pH regulator and water. The raw materials are as follows in parts by weight: Pregelatinized starch 50 parts, microcrystalline cellulose 30 parts, ethanol 20 parts, guar gum 5 parts, Bromothymol Blue 0.07 parts, purple potato anthocyanin 0.02 parts, curcumin 0.01 parts, and water 30 parts.

The preparation process of a cat litter additive for detecting the pH value of cat urine is as follows:
(1) Extract anthocyanins from purple potato, specifically including the following process, S1: Take purple potato powder, according to the solid-liquid ratio of 1:50 (g/mL) to add the extraction agent, the extraction agent is glacial acetic acid (mass fraction 1%) and ethanol mixed solution, magnetic stirring for 4 h, 800 rpm. S2: The solution obtained in step S1 was heated by ultrasound at 50° C. for 30 min, cooled to room temperature, stood for 24 h away from light, until fully combined, and then vacuum filtrated to obtain the anthocyanin solution of purple potato. S3: The anthocyanin content in the obtained solution was measured by spectrophotometer.
(2) Bromothymol blue, purple potato anthocyanin, curcumin and ethanol were mixed and stirred to obtain the organic phase.
(3) Pectin, sodium carboxymethyl cellulose and water are mixed and stirred to obtain the water phase.
(4) The aqueous phase and the organic phase are mixed to get the mixed liquid. Add citric acid and EDTA-2Na and adjust the pH to 2.9-3.0 to get the additive liquid phase.
(5) The liquid phase component of the additive is dropped onto the starch base material, the starch base material is automatically clumped to form particles, the particles are separated and collected, and the cat litter additive is freeze-dried.

In the above steps (1)-(5), by directly dropping the liquid component to the solid base material, the particles can be automatically clumped to form particles, and then the particles are separated from the base material by the vibrating screen, and the recovered base material can continue to be used for preparation, simplifying the production process, high yield, and saving a lot of costs. The use of freeze-drying method for drying can also avoid the influence of conventional high temperature drying on the pH indicator. high yield, and saving a lot of costs. The use of freeze-drying method for drying can also avoid the influence of conventional high temperature drying on the pH indicator.

Embodiment 2, a litter additive for the detection of pH in cat urine, consists of starch, microcrystalline cellulose, organic solvent, binder, pH indicator, pH regulator and water, in parts by weight of the following ingredients: Pregelatinized starch 80 parts, microcrystalline cellulose 60 parts, ethanol 30 parts, guar gum 7 parts, bromothymol blue 0.4 parts, purple potato anthocyanin 0.1 parts, curcumin 0.05 parts, water 50 parts. The preparation method of a cat litter additive for detecting pH value of cat urine is the same as that of Embodiment 1.

Embodiment 3, a cat litter additive for detecting the pH value of cat urine, the materials used include starch, microcrystalline cellulose, organic solvent, binder, pH indicator, pH regulator and water, and the raw material composition in parts by weight is as follows: Pregelatinized starch 120 parts, microcrystalline cellulose 80 parts, ethanol 40 parts, guar gum 10 parts, bromothymol blue 1 part, purple potato anthocyanin 0.07 parts, curcumin 0.03 parts, water 70 parts. The preparation method of a cat litter additive for detecting pH value of cat urine is the same as that of Embodiment 1.

Embodiment 4, a litter additive for detecting the pH of your cat's urine, consists of starch, microcrystalline cellulose, an organic solvent, a binder, a pH indicator, a pH regulator, and water, and differs from Embodiment 1 only in that the organic solvent ethanol is replaced with acetone. A litter additive for detecting the pH of your cat's urine is prepared in the same way as in Embodiment 1.

Embodiment 5, a litter additive for detecting the pH of your cat's urine, consists of starch, microcrystalline cellulose, organic solvent, binder, pH indicator, pH regulator, and water, which differs from Embodiment 1 only in that guar gum is replaced with pectin. A litter additive for detecting the pH of your cat's urine is prepared in the same way as in Embodiment 1.

Embodiment 6, a litter additive for detecting the pH of your cat's urine, consists of starch, microcrystalline cellulose, organic solvent, binder, pH indicator, pH regulator, and water, which differs from Embodiment 1 only in that the pre-gelatinized starch is replaced with maltodextrin. A litter additive for detecting the pH of your cat's urine is prepared in the same way as in Embodiment 1.

Embodiment 7, a litter additive for detecting the pH of your cat's urine, consists of starch, microcrystalline cellulose, organic solvent, binder, pH indicator, pH regulator, and water, which differs from Embodiment 1 only by replacing EDTA-2Na with sodium citrate.

Embodiment 8, a litter additive for detecting the pH of your cat's urine, using materials including starch, microcrystalline cellulose, organic solvent, binder, pH indicator, pH regulator, and water, differs from Embodiment 1 only by replacing citric acid and EDTA-2Na with Tris and hydrochloric acid. A litter additive for detecting the pH of your cat's urine is prepared in the same way as in Embodiment 1.

For ratio 1, a cat litter additive for detecting the pH of cat urine, which differs from Embodiment 1 only in that it does not contain purple potato anthocyanins and curcumin, its weight portion is divided into the weight of Bromothymol blue. A cat litter additive for detecting pH of cat urine is prepared in the same way as in Embodiment 1.

For proportion 2, a cat litter additive for detecting the pH of cat urine is the same as in Embodiment 1, except that it does not contain curcumin and its weight portions are divided proportionally among the weight of bromothymol blue and purple potato anthocyanins. A cat litter additive for detecting the pH of cat urine is prepared in the same way as in Embodiment 1.

For proportion 3, a litter additive for detecting pH in the urine of cats is the same as in Embodiment 1, except that it does not contain purple potato anthocyanins and its weight portions are divided proportionally among the weight of bromothymol blue and curcumin. A cat litter additive for detecting pH of cat urine is prepared in the same way as in Embodiment 1.

For proportion 4, a litter additive method for detecting pH of cat urine is the same as in Embodiment 1, except that it does not contain microcrystalline cellulose. The preparation method of a cat litter additive for detecting pH of cat urine is the same as that of Embodiment 1.

Effect test: Take Embodiment 1-8 and carry out color rendering effect test on ratio 1-4 finished particles.

Test methods: Take cat urine sample, add buffer solution, and configure different solutions with PH value 2, 3, 4, 5, 5.5, 6, 7, 7.5, 8, 9, 10, 11, 12, 13 for use. Take dry crystallized petri dishes, add appropriate particles of this product into each dish, corresponding to the prepared cat urine samples with different pH values, and the samples are just soaked with particles. Observe the color change of the particles after adding the cat urine samples with different pH values.

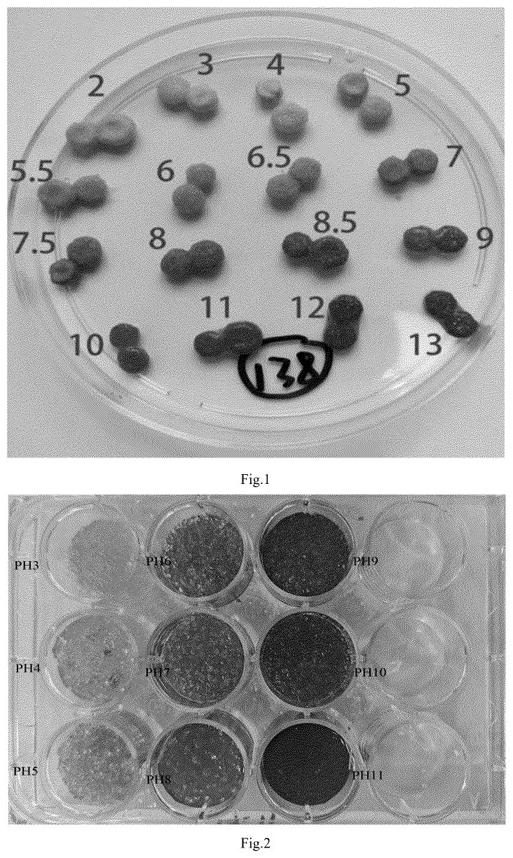

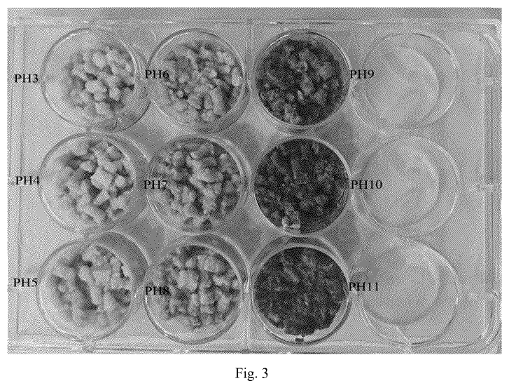

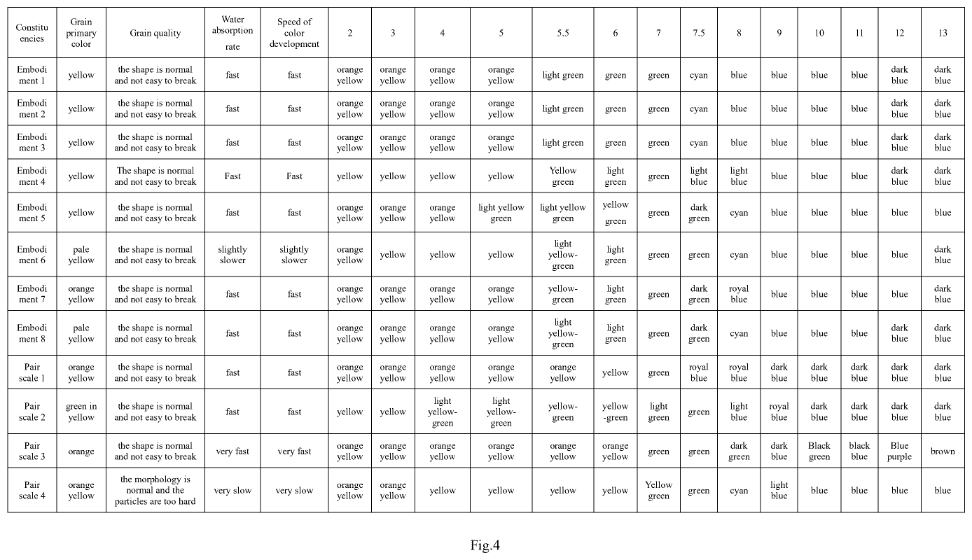

The results are shown in FIGS. 1, 2, 3, 4, which illustrate the color development of 1 different embodiments under different pH conditions. It can be found from the data in FIGS. 1, 2, 3, 4 that the additive prepared by the invention has high quality, is not easy to break, has fast water absorption speed and fast color developing speed; By comparing the embodiment 1 with the ratio 1-3, it can be found that the color developing effect of the invention can well fit the pH value range of normal urine of the cat by adopting a specific indicator combination; By comparing embodiments 1, 4-8 against ratio 4, it can be found that the invention can further improve the product quality and product effect by adopting specific organic solvents, binders, granular substrates, pH regulators and granular substrates.

The technical scheme of the invention mainly adopts starch base material, which is automatically clumped to form particles by liquid phase component dripping. In order to further broaden the application range of the invention and improve the applicability of the product, the following schemes can also be adopted. Scheme 1: Prepare additive solution by directly soaking silica gel sand particles: prepare additive solution by referring to the preparation method of additive in this application scheme. Soaking silica gel sand particles: the prepared additive solution is directly soaked in silica gel sand particles to make them fully absorb the additives. Drying: The soaked silica gel sand particles are dried. Drying, air drying and other methods can be used to ensure that the particles are dried thoroughly. Screening: The dried silica gel sand particles are screened to remove too large or too small particles to ensure that the particle size is uniform. Plan 2: Prepare additive solution with the production process of tofu cat litter: Prepare additive solution by referring to the preparation method of additives in the existing scheme. Cat litter production process: tofu litter base powder formula: bean curd residue 50%, pre-gelatinized starch 30%, microcrystalline cellulose 18%, sodium polyacrylate 2%, the base powder and the additive liquid phase in accordance with 7:3 mixing into granular cat litter through pelletizing mechanism, and molding, drying and other steps, the cat litter with pH detection function is prepared.

The following supplementary embodiment 1 can also be adopted. The present embodiment provides a preparation method of silica gel sand additive for detecting pH value of cat urine as follows: (1) Extraction of purple potato anthocyanins, specifically including the following process, S1: The purple potato powder was taken and the extraction agent was added at the solid-liquid ratio of 1:50 (g/mL). The extraction agent was a mixture of glacial acetic acid (mass fraction 1%) and ethanol, and was stirred magnetically for 4 h at 800 rpm. S2: The solution obtained in step S1 was heated by ultrasound at 50° C. for 30 min, cooled to room temperature, left for 24 h away from light, until fully combined, and after vacuum filtration, the anthocyanin solution of purple potato was obtained. S3: The anthocyanin content in the obtained solution was measured by spectrophotometer. (2) Bromothymol blue, purple potato anthocyanin, curcumin and ethanol were mixed and stirred to obtain the organic phase. (3) Pectin, sodium carboxymethyl cellulose and water were mixed and stirred evenly to obtain the aqueous phase. (4) The aqueous phase and the organic phase are mixed to get the mixed liquid. Add citric acid and EDTA-2Na and adjust the pH to 2.9-3.0 to get the additive liquid phase. (5) Soak the prepared additive solution directly in silica gel sand particles to fully absorb the additive. The soaked silica gel sand particles are dried, which can be dried, air dried and other methods to ensure that the particles are dried thoroughly. The dried silica gel sand particles are screened to remove too large or too small particles to ensure that the particle size is uniform.

In addition to Embodiment 2, the present embodiment provides a silica gel sand additive for detecting pH value of urine of cats and the preparation method is as follows: (1) Extracting anthocyanins from purple potato, specifically including the following process, S1: The purple potato powder was taken and the extraction agent was added at the solid-liquid ratio of 1:50 (g/mL). The extraction agent was a mixture of glacial acetic acid (mass fraction 1%) and ethanol, and was stirred magnetically for 4 h at 800 rpm. S2: The solution obtained in step S1 was heated by ultrasound at 50° C. for 30 min, cooled to room temperature, left for 24 h away from light, until fully combined, and after vacuum filtration, the anthocyanin solution of purple potato was obtained. S3: The anthocyanin content in the obtained solution was measured by spectrophotometer. (2) Bromothymol blue, purple potato anthocyanin, curcumin and ethanol were mixed and stirred to obtain the organic phase. 3) Pectin, sodium carboxymethyl cellulose and water were mixed and stirred evenly to obtain the aqueous phase. (4) Mix the aqueous phase with the organic phase to get the mixed liquid. Add citric acid and EDTA-2Na and adjust the pH to 2.9-3.0 to get the additive liquid phase. (5) Soak the prepared additive solution directly in silica gel sand particles to fully absorb the additive. The soaked silica gel sand particles are dried, which can be dried, air dried and other methods to ensure that the particles are dried thoroughly. The dried silica gel sand particles are screened to remove too large or too small particles to ensure that the particle size is uniform.

Through the supplementary technical scheme, the invention extends the application range: not only can be applied to starch base material, but also can be applied to silica gel sand particles, and can even be added to the commercially available cat litter to improve the applicability and market competitiveness of the product. The production process is simplified: the supplementary scheme can make full use of the existing production line and reduce the production cost and time. Excellent product performance: by soaking or mixing, the additive can fully contact with silica gel sand particles or other cat litter raw materials to ensure the effectiveness of pH detection function.

It should be noted that the cat litter additive of the invention and its preparation method and application are illustrated by the above embodiments, but the invention is not limited to the above embodiments, that is, it does not mean that the invention must rely on the above embodiments to be implemented. The technical personnel in the technical field of the invention should understand that any improvement of the invention, equivalent replacement of the raw materials of the product of the invention and the addition of auxiliary ingredients, the choice of specific methods, etc. fall within the scope of protection and disclosure of the invention.

The above describes the preferred embodiment of the invention in detail, however, the invention is not limited to the specific details of the embodiment, within the scope of the technical idea of the invention, can carry out a variety of simple variations of the technical scheme of the invention, these simple variations are within the scope of protection of the invention. In addition, it should be noted that each specific technical feature described in the above specific embodiments can be combined in any suitable way without contradiction. In order to avoid unnecessary repetition, the invention will not separately describe the various possible combination modes.

1. Cat litter additive for detecting pH value of cat urine, comprising starch, microcrystalline cellulose, organic solvent, binder, pH indicator, pH adjuster and water;
amount of the starch is 30-200 parts, the microcrystalline cellulose is 20-100 parts, the organic solvent is 10-60 parts, the binder is 1-20 parts, the pH indicator is 0.05-2 parts, the pH adjuster is 0.01-10 parts, the water is 0 -100 parts;
the starch is any one or at least two combinations of corn starch, tapioca starch, pea starch, mung bean starch, pregelatinized starch, hydroxymethyl starch or maltodextrin;
the organic solvent is any one or at least two combinations of ethanol, butanol, butylene glycol, ethylene glycol, ether, ethyl acetate, acetone, or pentane;
the binder comprises any one or at least two combinations of guar gum, pectin, xanthan gum, propylene glycol alginate, sodium polyacrylate, hydroxypropyl methyl cellulose and sodium carboxymethyl cellulose;
the indicator is bromothymol blue, purple sweet potato anthocyanins, curcumin composition;
the pH adjuster is one or at least two combinations of citric acid, sodium citrate, histidine, histidine salt, tris, EDTA-2Na, hydrochloric acid, sodium dibasic phosphate, disodium hydrogen phosphate, potassium dibasic phosphate.

2. The cat litter additive for detecting pH value of cat urine according to claim 1, wherein the starch, the microcrystalline cellulose, the organic solvent, the binder, the pH indicator, the pH adjuster and the water composition are calculated by weight, and 50-120 parts of the starch, 30-80 parts of the microcrystalline cellulose, 20-40 parts of the organic solvent, 5-10 parts of the binder, 0.1-1 part of the pH indicator, 1-5 parts of the pH adjuster and 30-70 parts of the water are preferred.

3. The cat litter additive for detecting pH value of cat urine according to claim 1, wherein the starch preferably pre-gelatinized starch.

4. The cat litter additive for detecting pH value of cat urine according to claim 1, wherein ethanol is preferred for organic solvent.

5. The cat litter additive for detecting pH value of cat urine according to claim 1, wherein guar gum is preferably selected for binder.

6. The cat litter additive for detecting pH value of cat urine according to claim 1, wherein the combination of citric acid and EDTA-2Na is preferably selected for the pH adjuster.

7. A preparation method of cat litter additive for detecting pH value of cat urine according to claim 1, comprising following steps:
(1) extracting purple sweet potato anthocyanins;
(2) the pH indicator is mixed with an organic solvent to obtain an organic phase;
(3) the binder is mixed with water to obtain the aqueous phase;
(4) Mix the aqueous phase and the organic phase to obtain the mixed solution, add the pH adjuster, adjust to the appropriate pH value to the additive liquid phase;
(5) the additive liquid phase component drops onto the starch base, and the starch base automatically agglomerates to form particles, separates and collects the particles, and freeze-dries to obtain the cat litter additive.

8. The preparation method of cat litter additive for detecting pH value of cat urine according to claim 7, wherein the extraction of purple sweet potato anthocyanins comprises the following step,
S1: take purple sweet potato powder, add extraction agent according to solid-liquid ratio of 1:50 (g/ml), the extracting agent is glacial acetic acid (mass fraction 1%) and ethanol mixture, stirring under magnetic conditions for 4 h, and the rotation speed is 800 rpm;
S2: After ultrasonic heat treatment, it was cooled to room temperature, protected from light and allowed to stand for 24 h until it was completely combined, and after vacuum filtration, purple potato anthocyanin solution was obtained;
S3: Measure the anthocyanin content in the obtained solution using a spectrophotometer.

9. The preparation method of cat litter additive for detecting pH value of cat urine according to claim 7, wherein in step S1, ethanol is 75%-100% volume fraction; The volume ratio of glacial acetic acid to ethanol is 1:1-2.

10. The preparation method of cat litter additive for detecting pH value of cat urine according to claim 7, wherein in step S1, the ultrasonic heating condition is 20-30 min, 45-50°C.
